(19) United States
(12) Patent Application Publication
(10) Pub. No.: US 2025/0254411 A1
(43) Pub. Date: Aug. 7, 2025

(54) LIGHT-EMITTING DEVICE

(71) Applicant: CANON KABUSHIKI KAISHA, Tokyo (JP)

(72) Inventors: HIROMASA TSUBOI, Tokyo (JP); MASATO YAJIMA, Tokyo (JP)

(21) Appl. No.: 19/039,710

(22) Filed: Jan. 28, 2025

(30) Foreign Application Priority Data
Feb. 2, 2024 (JP) 2024-014807

(51) Int. Cl. H04N 23/56; H04N 23/63; H04N 23/74

(52) U.S. Cl. CPC H04N 23/56; H04N 23/63; H04N 23/74

(57) ABSTRACT

A light-emitting device includes a light-emitting element, a first transistor and a second transistor disposed on a first surface of a silicon substrate, and a third transistor disposed in a peripheral circuit configured to supply a video signal to the first transistor. One of a source or a drain of the first transistor is connected to a gate electrode of the second transistor, and one of a source or a drain of the second transistor is connected to the light-emitting element. The first transistor includes a halo injection layer in diffusion regions of the source and the drain, and the halo injection layer is opposite in polarity to the diffusion regions.

### BACKGROUND OF THE INVENTION

### Field of the Disclosure

The present disclosure relates to a light-emitting device, and, for example, relates to a light-emitting device having light-emitting elements, and a display device and electronic equipment having the light-emitting device.

### Description of the Related Art

Some recently known display devices have light-emitting elements arranged in an array and configured to emit light with a luminance corresponding to electric current flowing through the elements, where organic electroluminescence (EL) elements have been used as the light-emitting elements. The applications of these display devices have expanded significantly, and there is a demand for higher definition and higher functionality in accordance with the applications.

Japanese Patent Application Laid-Open No. 2020-71323 (hereafter, PTL 1) discusses a display device that includes a silicide layer in order to reduce electrical resistance in the source and drain of a driving transistor in a driving circuit for an organic light-emitting element. The source and drain of the driving transistor in PTL 1 include the silicide layer that can reduce the resistance of the transistor. A device having a silicide layer may degrade the characteristics of the light-emitting elements, such as occurrence of a leakage current.

### SUMMARY OF THE INVENTION

The present disclosure is directed to providing a light-emitting device with reduced leakage current.

According to an aspect of the present disclosure, a light-emitting device includes a light-emitting element, a first transistor and a second transistor disposed on a first surface of a silicon substrate, and a third transistor disposed in a peripheral circuit configured to supply a video signal to the first transistor, wherein one of a source or a drain of the first transistor is connected to a gate electrode of the second transistor, wherein one of a source or a drain of the second transistor is connected to the light-emitting element, and wherein the first transistor includes a halo injection layer in diffusion regions of the source and the drain, and the halo injection layer is opposite in polarity to the diffusion regions.

Further features of the present disclosure will become apparent from the following description of exemplary embodiments with reference to the attached drawings.

### BRIEF DESCRIPTION OF THE DRAWINGS

FIG. 1 is a schematic diagram illustrating an example of a light-emitting device according to an exemplary embodiment.

FIG. 2 is a circuit diagram illustrating an example of a pixel circuit of the light-emitting device according to a first exemplary embodiment.

FIG. 3 is a plan view of an example of a circuit of the light-emitting device according to the first exemplary embodiment.

FIG. 4 is a cross-sectional view of an example of the light-emitting device according to the first exemplary embodiment.

FIG. 5 is a plan view of an example of a peripheral circuit transistor of a light-emitting device according to a second exemplary embodiment.

FIG. 6 is a cross-sectional view of an example of a peripheral circuit transistor of the light-emitting device according to the second exemplary embodiment.

FIG. 7 is a schematic diagram illustrating an example of a light-emitting device according to a third exemplary embodiment.

FIG. 8 is a circuit diagram illustrating an example of a pixel circuit of the light-emitting device according to the third exemplary embodiment.

FIG. 9 is a plan view of an example of a circuit of the light-emitting device according to the third exemplary embodiment.

FIG. 10 is a cross-sectional view of an example of the light-emitting device according to the third exemplary embodiment.

FIG. 11 is a schematic diagram illustrating an example of a light-emitting device according to a fourth exemplary embodiment.

FIG. 12 is a circuit diagram illustrating an example of a pixel circuit of the light-emitting device according to the fourth exemplary embodiment.

FIG. 13 is a plan view of an example of a circuit of the light-emitting device according to the fourth exemplary embodiment.

FIG. 14 is a cross-sectional view of an example of the light-emitting device according to the fourth exemplary embodiment.

FIG. 15 is a circuit diagram illustrating an example of an inverter circuit of a light-emitting device according to a fifth exemplary embodiment.

FIG. 16 is a circuit diagram illustrating an example of an inverter circuit of the light-emitting device according to the fifth exemplary embodiment.

FIG. 17 is a circuit diagram illustrating an example of an inverter circuit of the light-emitting device according to the fifth exemplary embodiment.

FIG. 18 is a schematic diagram illustrating an example of a display device according to an exemplary embodiment of the present disclosure.

FIG. 19A is a schematic diagram illustrating an example of an imaging device according to an exemplary embodiment of the present disclosure, and FIG. 19B is a schematic diagram illustrating an example of electronic equipment according to an exemplary embodiment of the present disclosure.

FIGS. 20A and 20B are schematic diagrams illustrating examples of display devices according to exemplary embodiments of the present disclosure.

FIGS. 21A and 21B are schematic diagrams illustrating an example of a wearable device according to an exemplary embodiment of the present disclosure.

### DESCRIPTION OF THE EMBODIMENTS

A light-emitting device according to an exemplary embodiment of the present disclosure includes a light-emitting element, a first transistor and a second transistor disposed on a first surface of a silicon substrate, and a third transistor disposed in a peripheral circuit that supplies video signals to the first transistor. Either a source or a drain of the first transistor is connected to a gate electrode of the second transistor, and either a source or a drain of the second transistor is connected to the light-emitting element. The first transistor has halo injection layers in diffusion regions of the source and drain, and the halo injection layers are opposite in polarity to the diffusion regions.

Providing the halo injection layers in the first transistor reduces a leakage current in the light-emitting device.

Hereinafter, exemplary embodiments will be described in detail with reference to the accompanying drawings. The following exemplary embodiments do not limit the invention according to the claims. Although the described exemplary embodiments have a plurality of features, not all of these features are essential to the invention, and the plurality of features may be combined in any manner. Furthermore, in the accompanying drawings, the same reference numbers are used for the same or similar configurations, and duplicated descriptions thereof will be omitted.

In the following exemplary embodiments, a driving transistor is connected to the anode of an organic light-emitting element and all the transistors are P-type transistors. However, the light-emitting device of the present disclosure is not limited to this configuration. The polarity and conductivity type may all be reversed. The transistors may be either P-type transistors or N-type transistors, and in order to change this, the supplied potential or connection may be changed as appropriate according to the conductivity type and polarity.

In the following exemplary embodiments, the peripheral circuits may be disposed on the same silicon substrate as that of the transistors such as the driving transistor, or may be disposed on a second silicon substrate that is different from the above-described silicon substrate.

The light-emitting element herein may be an organic light-emitting element serving as a light-emitting layer having an organic compound in a light-emitting portion, or may be an inorganic light-emitting element having a light-emitting portion made of an inorganic compound.

The organic light-emitting element includes an organic layer including a light-emitting layer between an anode and a cathode. The organic layer may include one or more of a hole injection layer, a hole transport layer, an electron injection layer, and an electron transport layer, as appropriate, in addition to the light-emitting layer. A display device having an organic light-emitting element is an example of a light-emitting device, and is also called an organic light-emitting device. In the following exemplary embodiments, an example case where an organic light-emitting element is used will be described.

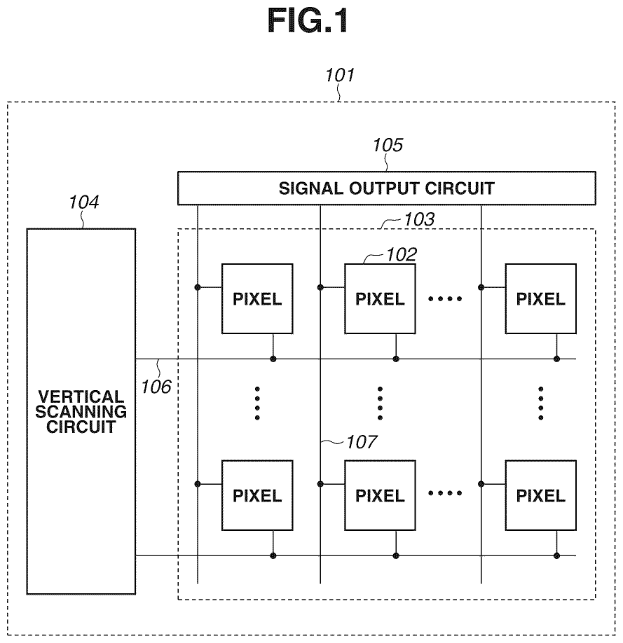

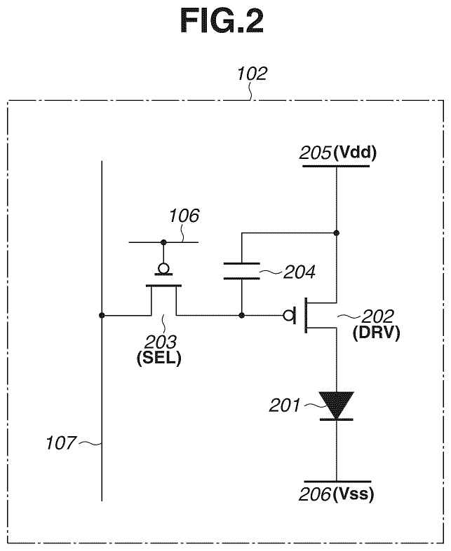

A first exemplary embodiment of the present disclosure will be described below. FIG. 1 is a schematic diagram of an example of a light-emitting device according to the present exemplary embodiment. The light-emitting device 101 includes a pixel array portion 103 and a peripheral circuit portion arranged around the pixel array portion 103. The pixel array portion 103 includes a plurality of pixels 102 arranged two-dimensionally in a matrix, and each pixel 102 includes an organic light-emitting element 201 (illustrated in FIG. 2).

The light-emitting device 101 includes a peripheral circuit portion that drives each pixel 102. The peripheral circuit portion includes a vertical scanning circuit 104 and a signal output circuit 105, for example. In the pixel array portion 103, a first scanning line 106 is arranged for each pixel row in the row direction, and a signal line 107 is arranged for each pixel column in the column direction.

Each first scanning line 106 is connected to an output terminal of a corresponding row in the vertical scanning circuit 104. Each signal line 107 is connected to an output terminal of a corresponding column in the signal output circuit 105. The vertical scanning circuit 104 supplies to the first scanning lines 106, a write control signal that controls the timing for writing a video signal to each pixel 102 of the pixel array portion 103. The signal output circuit 105 outputs a luminance signal having a voltage corresponding to luminance information.

FIG. 2 is a circuit diagram illustrating an example of a pixel circuit included in the light-emitting device 101 of FIG. 1. Each pixel 102 includes the light-emitting element 201, a driving transistor 202 (DRV), a write transistor 203 (SEL), and a first capacitive element 204. One of the source and drain of the driving transistor 202 is connected to a first electrode of the light-emitting element 201, and the other of the source and drain of the driving transistor 202 is connected to a first power supply terminal 205 (hereinafter, Vdd). A second electrode of the light-emitting element 201 is connected to a second power supply terminal 206 (hereinafter, Vss).

One of the source and drain of the write transistor 203 is connected to the gate electrode of the driving transistor 202, and the other of the source and drain of the write transistor 203 is connected to the signal line 107. The gate electrode of the write transistor 203 is connected to the first scanning line 106.

The first capacitive element 204 is connected between the gate and one of the source and drain (here, the source) of the driving transistor 202, and holds a luminance signal in the pixel 102. The first capacitive element 204 may be any of a parasitic capacitance, a gate-channel capacitance of a metal oxide semiconductor (MOS), a metal-insulator-metal (MIM) structure, and a metal-oxide-metal (MOM) structure.

In the present exemplary embodiment, the drain of the driving transistor 202 is connected to the anode of the light-emitting element 201, and the source of the driving transistor 202 is connected to the first power supply terminal 205 (Vdd).

The first capacitive element 204 is connected between the gate electrode of the driving transistor 202 and the source of the driving transistor 202, and holds a luminance signal in the pixel 102. The first capacitive element 204 according to the present exemplary embodiment has a MIM structure.

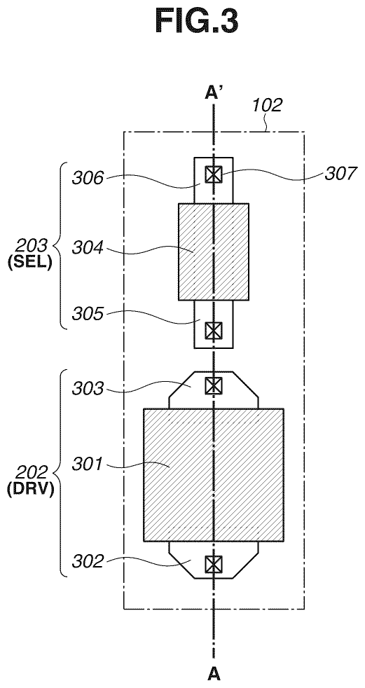

FIG. 3 is a plan view of an example of the circuit illustrated in FIG. 2. The driving transistor 202 includes a gate electrode 301, a source 302, and a drain 303.

The write transistor 203 includes a gate electrode 304, a source 305, and a drain 306. Contact electrodes 307 are connected to a trace of wiring in other layers.

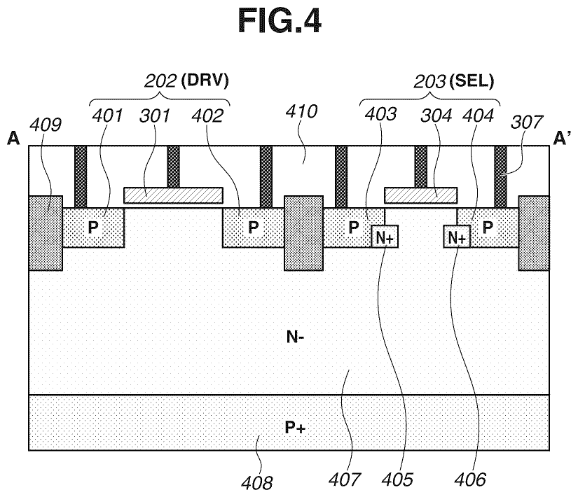

FIG. 4 is a cross-sectional view taken along line A-A′ in the plan view of FIG. 3. The source and the drain of the driving transistor 202 are formed of P-type diffusion layers 401 and 402, respectively.

The source and drain of the write transistor 203 are formed by P-type diffusion layers 403 and 404, respectively. High-concentration N-type diffusion layers 405 and 406, which are halo injection layers, are adjacent to the P-type diffusion layers 403 and 404, respectively. A lower-concentration N-type well layer 407 is disposed between the high-concentration N-type diffusion layers 405 and 406.

The driving transistor 202 has a structure in which no halo injection layers are disposed. The driving transistor 202 supplies a subthreshold current to the light-emitting element. Thus, if a halo injection layer is disposed, the subthreshold current may vary significantly in the pixel 102 even though the concentration variation is slight. Excluding the halo injection layer can lead to a reduction in the variation of the current to be supplied by the driving transistor 202 to the organic light-emitting element 201.

The transistors according to the present exemplary embodiment are all disposed on the N-type well layer 407 and a P-type substrate 408, and are isolated from each other by insulator separation units 409. The insulator separation units 409 may employ any structure of shallow trench isolation (STI) isolation, local oxidation of silicon (LOCOS) isolation, and N-type diffusion layer isolation.

An insulation layer 410 is an insulation layer disposed between the light-emitting element 201 and the first surface of the silicon substrate. The insulation layer 410 is also called an interlayer insulation layer and constitutes a wiring layer of the light-emitting device 101. The contact electrodes 307 contact the sources, drains, and gate electrodes of the driving transistor 202 and the write transistor 203 through openings formed in the insulation layer 410.

In the present exemplary embodiment, the write transistor 203 includes halo injection layers in the source and drain diffusion regions, and the halo injection layers are opposite in polarity to the diffusion regions.

Such a configuration reduces a leakage current flowing from the source to the drain of the write transistor 203 and into the first capacitive element 204, thereby reducing fluctuations in the luminance signal held by the first capacitive element 204. Therefore, the light-emitting element 201 can emit light stably with a predetermined luminance.

In the present exemplary embodiment, the driving transistor 202 that has no halo injection layers opposite in polarity to the diffusion regions in the diffusion regions of the source and drain, thus reducing variation in the amount of electric current to be supplied from the driving transistor 202 to the organic light-emitting element 201.

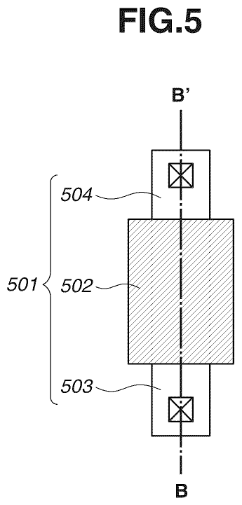

A second exemplary embodiment of the present disclosure will be described below. In the present exemplary embodiment, a peripheral circuit transistor 501 (illustrated in FIG. 5) includes a halo structure. The following description will focus on the differences from the other exemplary embodiments.

FIG. 5 is a plan view of an example of a transistor in a peripheral circuit portion. The peripheral circuit transistor 501 includes a gate electrode 502, a source 503, and a drain 504.

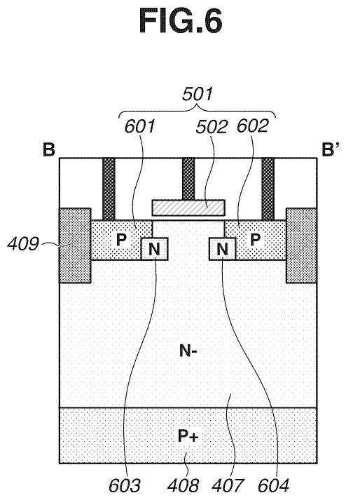

FIG. 6 is a cross-sectional view taken along line B-B′ in the plan view of FIG. 5. The source 503 and drain 504 of the peripheral circuit transistor 501 are formed by P-type diffusion layers 601 and 602, respectively. N-type diffusion layers 603 and 604, which are halo injection layers, are adjacent to the P-type diffusion layers 601 and 602, respectively. A lower-concentration N-type well layer 407 is disposed between the N-type diffusion layers 603 and 604. In the present exemplary embodiment, the peak concentration of high-concentration N-type diffusion layers 405 and 406 constituting a write transistor 203 is higher than the peak concentration of the N-type diffusion layers 603 and 604 of the peripheral circuit transistor 501. However, the present disclosure is not limited to this. The concentration of the halo injection layers may be adjusted as appropriate depending on the amount of leakage current, and the magnitude relationship in concentration may be reversed.

In the present exemplary embodiment, the peripheral circuit transistor 501 includes halo injection layers in the diffusion regions of the source and drain, and the halo injection layers are opposite in polarity to the diffusion regions. A peak impurity concentration in the halo injection layers of the write transistor 203 is different from a peak impurity concentration in the halo injection layers of the peripheral circuit transistor 501, and in particular, the peak concentration of the halo injection layers of the write transistor 203 is higher than the peak concentration of the halo injection layers of the peripheral circuit transistor 501.

This configuration enables control of a leakage current flowing from the source to the drain of the peripheral circuit transistor 501, thus reducing the current consumption in the peripheral circuit portion.

A third exemplary embodiment of the present disclosure will be described below. The present exemplary embodiment includes a light emission control transistor that is disposed between a driving transistor and a power source that supplies electric current to a light-emitting element. More specifically, the present exemplary embodiment includes a light emission control transistor that controls the current supply from a Vdd 205 to a driving transistor 202. The following description will focus on the differences from the other exemplary embodiments. The light emission control transistor will also be called a fourth transistor following a driving transistor, a write transistor, and a peripheral circuit transistor. The light emission control transistor may also be called a light emission period control transistor because it controls the light emission period. The following description will focus on the differences from the other exemplary embodiments.

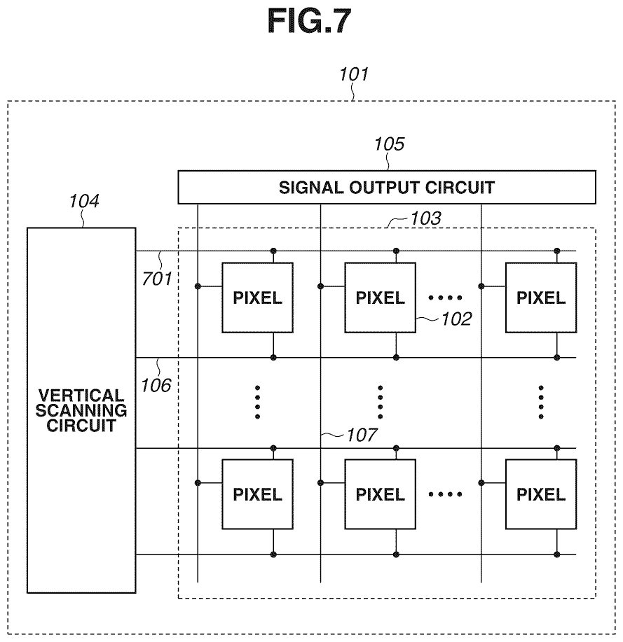

FIG. 7 is a schematic diagram illustrating an example of a light-emitting device according to the present exemplary embodiment. In a pixel array portion 103, a second scanning line 701 is arranged for each pixel row in the row direction. Each second scanning line 701 is connected to an output terminal of a corresponding row in a vertical scanning circuit 104, and supplies a light emission control signal to each pixel 102.

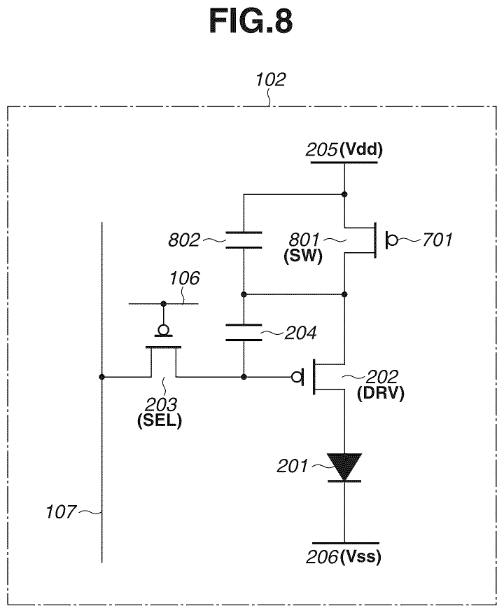

FIG. 8 is a circuit diagram illustrating an example of a pixel included in a light-emitting device 101 illustrated in FIG. 7. One of the source and drain (here, the drain) of a light emission control transistor 801 is connected to one of the source and drain (here, the source) of the driving transistor 202. The other of the light emission control transistor 801 (here, the source) is connected to a Vdd 205. The gate of the light emission control transistor 801 is connected to the second scanning line 701.

A second capacitive element 802 is connected between the drain of the light emission control transistor 801 and the Vdd 205. The second capacitive element 802 may be any of a parasitic capacitance, a gate-channel capacitance of a MOS, a MIM structure, or a MOM structure.

The light emission control transistor 801 responds to a light emission control signal applied from the vertical scanning circuit 104 to the gate via the second scanning line 701, and is turned on to allow current supply from the Vdd 205 to the driving transistor 202. This enables an organic light emitting element 201 to emit light by the driving transistor 202. That is, the light emission control transistor 801 functions as a transistor that controls the light emission and non-light emission of the organic light-emitting element 201. In this manner, the switching operation of the light emission control transistor 801 enables duty control by which to control the ratio between the light emission period and non-light emission period of the organic light-emitting element 201. This duty control can reduce afterimage blurring resulting from light emission of the pixel 102 over one frame period, and can improve the quality of moving images in particular.

Due to manufacturing variations, the threshold value of the driving transistor 202 may differ from pixel to pixel. If the same signal voltage is written to a plurality of pixels with the same emission color, the amount of electric current flowing through the driving transistor 202 differs from pixel to pixel, resulting in variation in the amount of light emission. Therefore, before writing the signal voltage, a threshold correction operation is performed to hold a threshold value between the gate and source of the driving transistor 202. This threshold correction operation can reduce the variation in the amount of electric current in the driving transistor 202 of each pixel, thus achieving more uniform light emission.

In the threshold correction operation, electric current is passed through the organic light-emitting element 201 via the light emission control transistor 801 and the driving transistor 202, and then the light emission control transistor 801 is turned off. Accordingly, electric current flows through the organic light-emitting element 201 until the voltage between the gate and source of the driving transistor 202 becomes statically stable, whereby threshold correction is performed.

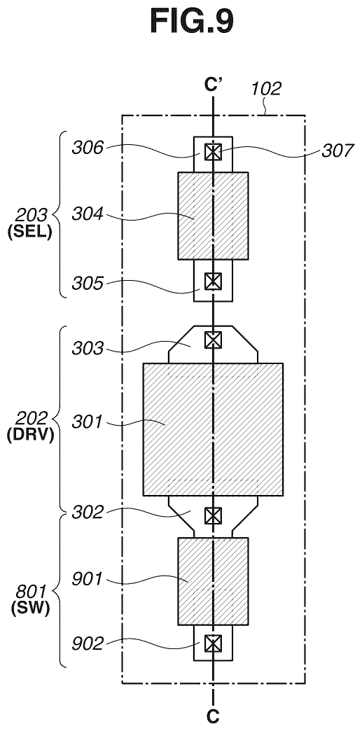

FIG. 9 is a plan view of an example of the circuit illustrated in FIG. 8. The light emission control transistor 801 includes a gate electrode 901, a source portion 902, and a drain portion 302.

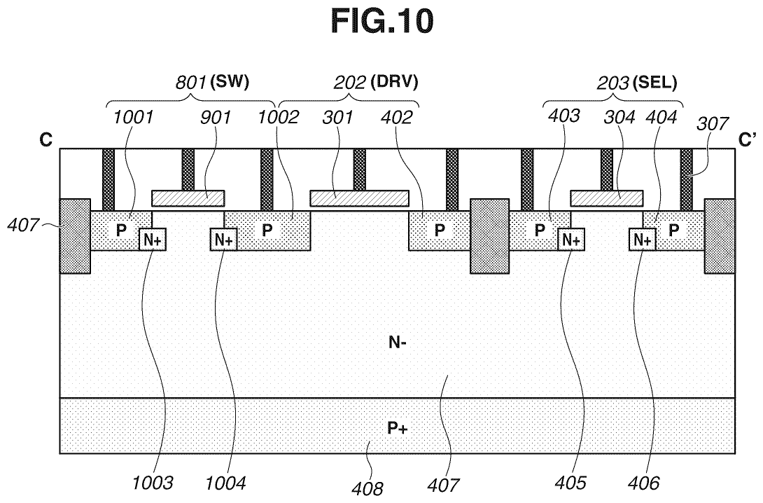

FIG. 10 is a cross-sectional view taken along line C-C′ in the plan view of FIG. 9. The source portion and drain portion of the light emission control transistor 801 are formed by P-type diffusion layers 1001 and 1002, respectively. High-concentration N-type diffusion layers 1003 and 1004, which are halo injection layers, are adjacent to the P-type diffusion layers 1001 and 1002, respectively. A lower-concentration N-type well layer 407 is disposed between the high-concentration N-type diffusion layers 1003 and 1004. In the present exemplary embodiment, the peak concentration of the high-concentration N-type diffusion layers 1003 and 1004 of the light emission control transistor 801 is higher than the peak concentration of the N-type diffusion layers 603 and 604 of a peripheral circuit transistor 501. However, the present disclosure is not limited to this configuration, and the concentration of the halo injection layers may be adjusted as appropriate depending on the amount of leakage current, and the magnitude relationship in concentration may be reversed.

In the present exemplary embodiment, a peak impurity concentration in the halo injection layers of the light emission control transistor is higher than a peak impurity concentration in the halo injection layers of the peripheral circuit transistor.

A peak impurity concentration in the halo injection layers of the light emission control transistor may be the same as a peak impurity concentration in the halo injection layers of the write transistor.

This configuration reduces a leakage current flowing from the source to the drain of the light emission control transistor 801 and into the first capacitive element 204 at the time of threshold correction, thus controlling fluctuations in the threshold voltage held by the first capacitive element 204.

A fourth exemplary embodiment of the present disclosure will be described below. In the present exemplary embodiment, a reset transistor is arranged between a terminal of a driving transistor, which is either a drain or a source of the driving transistor, that is connected to a light-emitting element and a terminal lower in potential than a power source that supplies electric current to the light-emitting element. More specifically, the present exemplary embodiment includes the reset transistor configured to reset the light-emitting element 201 by connecting the anode of a light-emitting element 201 to a third power supply terminal 1202 (hereinafter, Vres). The reset transistor will also be called a fifth transistor following a light emission control transistor. The third power supply terminal 1202 may be a power source lower in potential than the power source that supplies electric current to the light-emitting element 201. The third power supply terminal 1202 according to the present exemplary embodiment includes a potential for the reset transistor to reset the light-emitting element 201, but the third power supply terminal is not limited to the present exemplary embodiment. The following description will focus on the differences from the other exemplary embodiments.

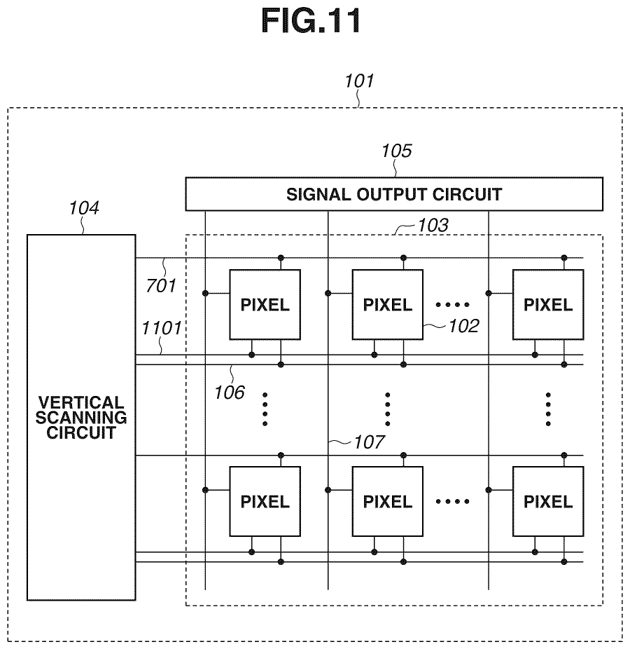

FIG. 11 is a schematic diagram illustrating an example of a light-emitting device according to the present exemplary embodiment. In a pixel array portion 103, a third scanning line 1101 is arranged for each pixel row in the row direction. Each third scanning line 1101 is connected to an output terminal of a corresponding row in a vertical scanning circuit 104, and supplies a reset signal to the pixel 102.

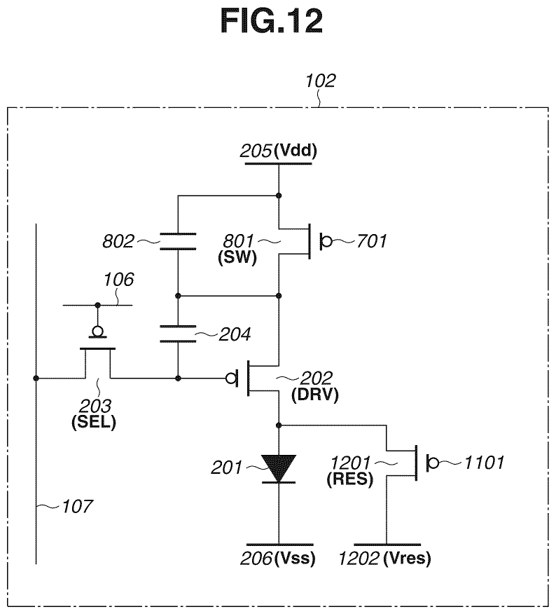

FIG. 12 is a circuit diagram illustrating an example of a pixel circuit included in the light-emitting device of FIG. 11. One of the source or drain (here, the source) of a reset transistor 1201 is connected to one of the source or drain (here, the drain) of a driving transistor 202. The other of the reset transistor 1201 is connected to a third power supply terminal 1202 (hereinafter, Vres). The gate of the reset transistor 1201 is connected to the third scanning line 1101. By turning on the reset transistor 1201, the anode of the organic light-emitting element 201 is connected to the Vres 1202, and the luminance of the organic light-emitting element 201 can be set to a black level. This makes it possible to achieve a high-contrast light-emitting device. During the light-emitting period, the reset transistor 1201 is in an off state.

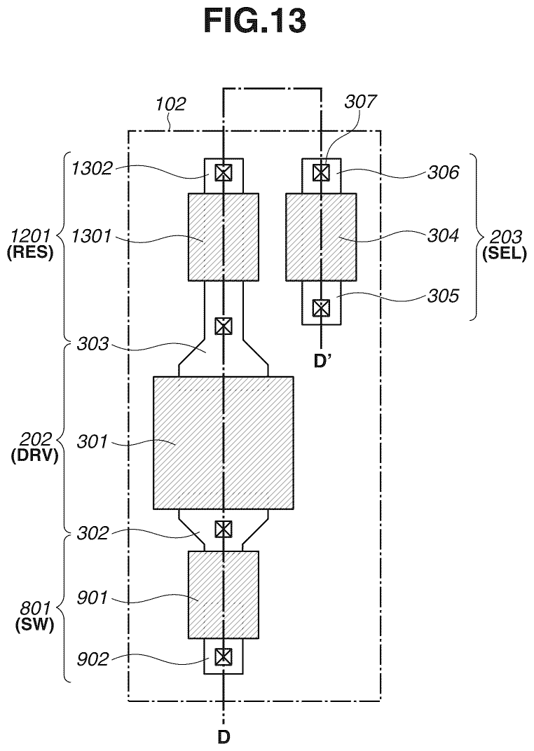

FIG. 13 is a plan view of an example of the circuit illustrated in FIG. 12. The reset transistor 1201 includes a gate electrode 1301, a source 303, and a drain 1302.

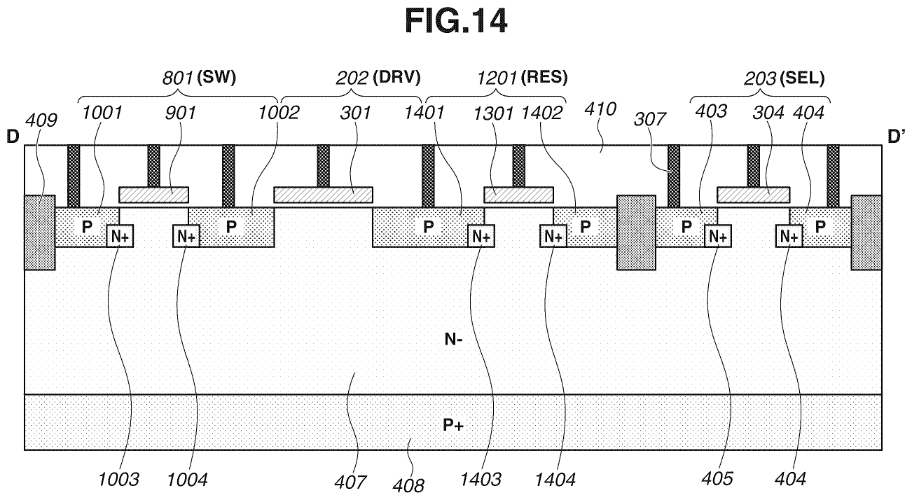

FIG. 14 is a cross-sectional view taken along line D-D′ in the plan view of FIG. 13. The source and drain of the reset transistor 1201 are formed by P-type diffusion layers 1401 and 1402, respectively. High-concentration N-type diffusion layers 1403 and 1404, which are halo injection layers, are adjacent to the P-type diffusion layers 1401 and 1402, respectively. A lower-concentration N-type well layer 407 is disposed between the high-concentration N-type diffusion layers 1403 and 1404. In the present exemplary embodiment, the peak concentration of the high-concentration N-type diffusion layers 1403 and 1404 of the reset transistor 1201 is higher than the peak concentration of N-type diffusion layers 603 and 604 of a peripheral circuit transistor 501. However, the present disclosure is not limited to this configuration. The concentration of the halo injection layers may be adjusted as appropriate depending on the amount of leakage current, and the magnitude relationship in concentration may be reversed.

In the present exemplary embodiment, a peak impurity concentration in the halo injection layers of the peripheral circuit transistor 501 is different from a peak impurity concentration in the halo injection layers of the reset transistor 1201.

A peak impurity concentration in the halo injection layers of the reset transistor 1201 may be higher than a peak impurity concentration in the halo injection layers of the peripheral circuit transistor 501.

A peak impurity concentration in the halo injection layers of the reset transistor 1201 may be the same as a peak impurity concentration in the halo injection layers of a write transistor.

This configuration controls a leakage current flowing from the source to the drain of the reset transistor 1201. Accordingly, during the light emission period, it is possible to control a leakage current flowing from the driving transistor 202 through the reset transistor 1201 to the Vres 1202, and reduce the current consumption of the pixel 102.

A fifth exemplary embodiment of the present disclosure will be described below. In the present exemplary embodiment, transistors of an inverter circuit 1501 in a vertical scanning circuit 104 have a halo structure. The following description will focus on the differences from the other exemplary embodiments.

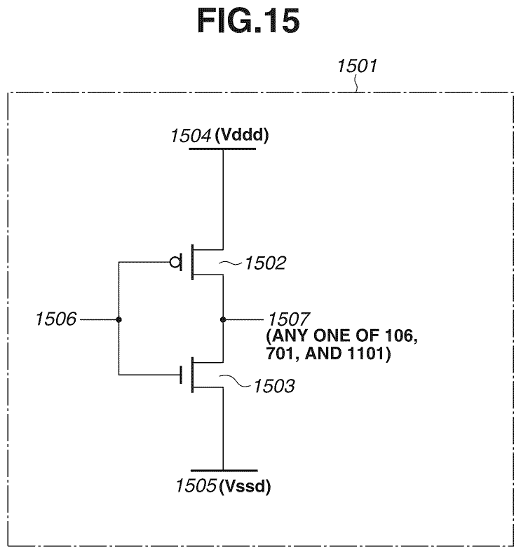

FIG. 15 is a circuit diagram of an example of the inverter circuit 1501 in the vertical scanning circuit 104 of the light-emitting device illustrated in FIG. 11. As illustrated in FIG. 15, the drain, source, and gate electrode of a P-type transistor 1502 are connected to the drain of an N-type transistor 1503, a fourth power supply terminal 1504 (hereinafter, Vddd), and the gate electrode of the N-type transistor 1503, respectively.

The source of the N-type transistor 1503 is connected to a fifth power supply terminal 1505 (hereinafter, Vssd).

The inverter circuit 1501 includes an input terminal 1506 and an output terminal 1507. The input terminal 1506 is connected to the gates of the P-type transistor 1502 and N-type transistor 1503. The output terminal 1507 is connected to the drain of the P-type transistor 1502 and the drain of the N-type transistor 1503, and further connected to any one of a first scanning line 106, a second scanning line 701, or a third scanning line 1101.

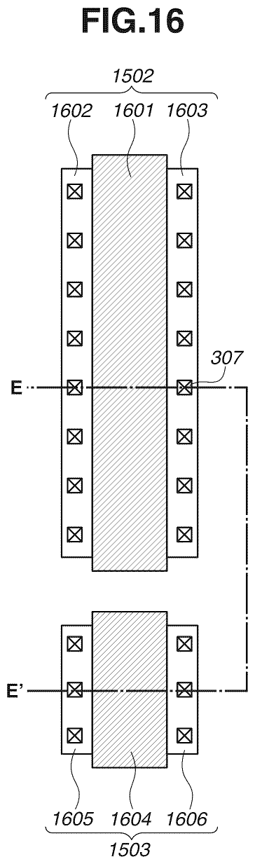

FIG. 16 is a plan view of an example of the circuit illustrated in FIG. 15. The P-type transistor 1502 includes a gate electrode 1601, a source portion 1602, and a drain portion 1603.

The N-type transistor 1503 includes a gate electrode 1604, a source 1605, and a drain 1606.

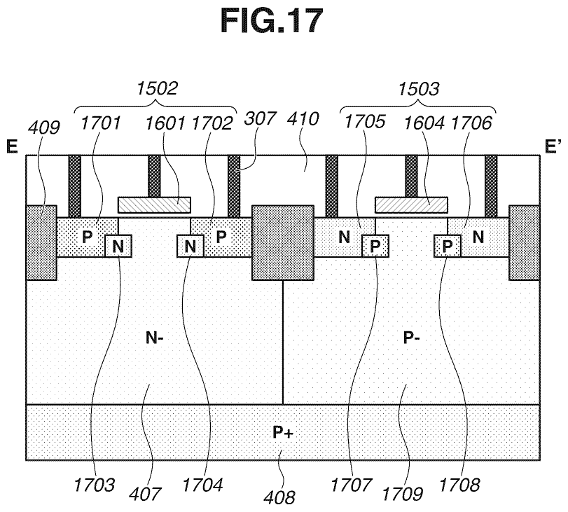

FIG. 17 is a cross-sectional view taken along line E-E′ in the plan view of FIG. 16. The source and drain of the P-type transistor 1502 are formed by P-type diffusion layers 1701 and 1702, respectively.

N-type diffusion layers 1703 and 1704, which are halo injection layers, are adjacent to the P-type diffusion layers 1701 and 1702, respectively. A lower-concentration N-type well layer 407 is disposed between the N-type diffusion layers 1703 and 1704.

The drain and source of the N-type peripheral circuit transistor 1503 are formed by N-type diffusion layers 1705 and 1706, respectively. P-type diffusion layers 1707 and 1708, which are halo injection layers, are adjacent to the N-type diffusion layers 1705 and 1706, respectively. A lower concentration P-type well layer 1709 is disposed between the P-type diffusion layers 1707 and 1708.

This configuration reduces a leakage current flowing from the Vddd 1504 into the Vssd 1505 via the P-type peripheral circuit transistor 1502 and the N-type peripheral circuit transistor 1503, thereby reducing the current consumption of the vertical scanning circuit 104.

### OTHER EXEMPLARY EMBODIMENTS

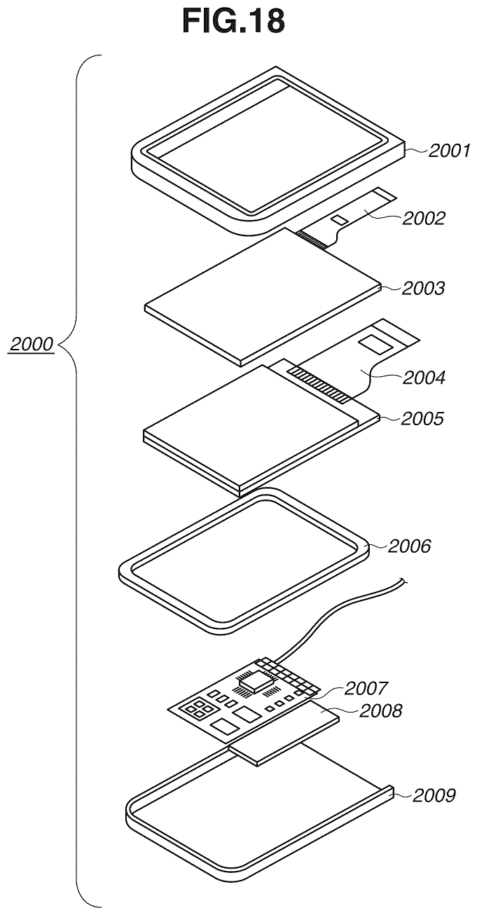

FIG. 18 is a schematic diagram illustrating an example of a display device according to the present exemplary embodiment. A display device 2000 may have a touch panel 2003, a display panel 2005, a frame 2006, a circuit board 2007, and a battery 2008 between an upper cover 2001 and a lower cover 2009. Flexible printed circuits (FPCs) 2002 and 2004 are connected to the touch panel 2003 and the display panel 2005. A transistor is printed on the circuit board 2007. The battery 2008 may be omitted if the display device is not a portable device, and may be disposed in a different position even if the display device is a portable device.

The display device 2000 according to the present exemplary embodiment may have color filters of red, green, and blue. The color filters may be arranged in a delta array with the red, green, and blue colors.

The display device 2000 according to the present exemplary embodiment may be used as a display unit of a portable terminal. In this case, the display device 2000 may have both a display function and an operation function. Examples of the portable terminal include mobile phones such as smartphones, tablets, and head-mounted displays.

The display device 2000 according to the present exemplary embodiment may be used as a display unit of an imaging device that includes an optical unit including a plurality of lenses and an imaging element that receives light having passed through the optical unit. The imaging device may have a display unit that displays information acquired by the imaging element. The display unit may be exposed to the outside of the imaging device, or may be disposed within the viewfinder. The imaging device may be a digital camera or a digital video camera.

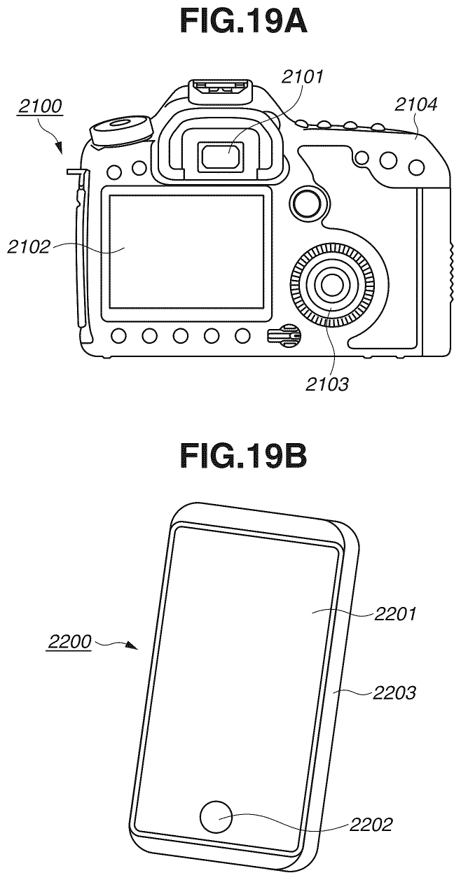

FIG. 19A is a schematic diagram illustrating an example of an imaging device according to the present exemplary embodiment. An imaging device 2100 may have a viewfinder 2101, a rear display 2102, an operation unit 2103, and a housing 2104. The viewfinder 2101 may have a display device according to the present exemplary embodiment. In this case, the display device may display not only a captured image but also environmental information, imaging instructions, and the like. The environmental information may include the intensity of external light, the direction of external light, the moving speed of a subject, the possibility that the subject will be hidden by an obstruction, and the like.

Since the timing suitable for imaging is short, it is better to display information as soon as possible. Therefore, it is desirable to use a display device equipped with the organic light-emitting element according to the present invention. This is because the organic light-emitting element has a fast response speed. A display device using the organic light-emitting element can be used more suitably than liquid crystal display devices, where display speed is demanded.

The imaging device 2100 includes an optical unit (not illustrated). The optical unit includes a plurality of lenses, which form an image on an imaging element housed in a housing 2104. The focus of the plurality of lenses can be adjusted by adjusting their relative positions. This operation can also be performed automatically. The imaging device may be called a photoelectric conversion device. The photoelectric conversion device can use, as an imaging method, an imaging method by which images are not captured sequentially but differences from the previous image are detected or parts are cuts out from an image that is always recorded, or the like.

FIG. 19B is a schematic diagram illustrating an example of electronic equipment according to the present exemplary embodiment. The electronic device 2200 includes a display unit 2201, an operation unit 2202, and a housing 2203. The housing 2203 may have a circuit, a printed circuit board having the circuit, a battery, and a communication unit. The operation unit 2202 may be a button or a touch panel-type reaction unit. The operation unit may be a biometric recognition unit that recognizes a fingerprint and performs unlocking, or the like. The communication unit communicates with the outside in a wired or wireless manner. Electronic equipment having a communication unit may be called a communication device. The electronic device may further have a camera function by including a lens and an imaging element. An image captured by the camera function is displayed on the display unit.

Examples of the electronic device include a smartphone and a laptop computer.

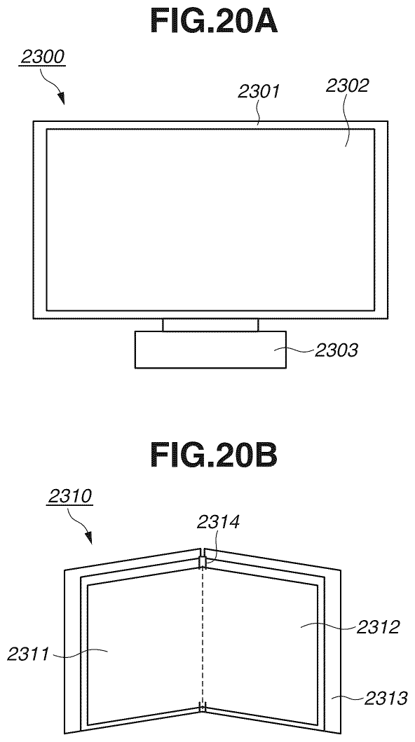

FIGS. 20A and 20B are schematic diagrams illustrating examples of a display device according to the present exemplary embodiment. FIG. 20A illustrates a display device such as a television monitor or a personal computer (PC) monitor. A display device 2300 includes a frame 2301 and a display unit 2302. The display unit 2302 may be the light-emitting device according to the present exemplary embodiment.

The display device 2300 includes the frame 2301 and a base 2303 that supports the display unit 2302. The base 2303 is not limited to the form illustrated in FIG. 20A. The lower side of the frame 2301 may also serve as the base.

The frame 2301 and the display unit 2302 may be curved. The radius of curvature may be 5000 mm or more and 6000 mm or less.

FIG. 20B is a schematic diagram illustrating another example of the display device according to the present exemplary embodiment. The display device 2310 in FIG. 20B is foldable, and is a foldable display device. The display device 2310 includes a first display unit 2311, a second display unit 2312, a housing 2313, and a bending point 2314. The first display unit 2311 and the second display unit 2312 may have the light-emitting device according to the present exemplary embodiment. The first display unit 2311 and the second display unit 2312 may be one display unit without a joint. The first display unit 2311 and the second display unit 2312 can be separated at the bending point 2314. The first display unit 2311 and the second display unit 2312 may display different images, or may display one image.

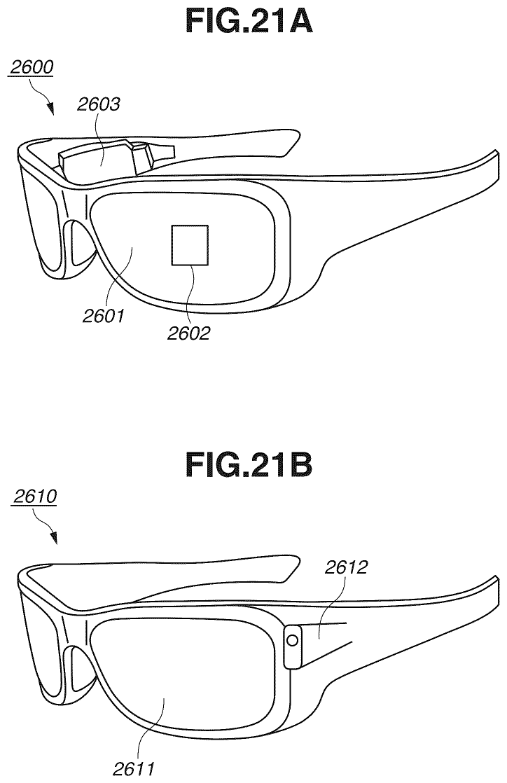

FIGS. 21A and 21B are schematic diagrams illustrating examples of wearable devices according to the present exemplary embodiment. The wearable device can be applied to a system that can be worn as a wearable device, such as smart glasses, a head-mounted device (HMD), or a smart contact lens. An imaging and displaying device used in such an application example includes an imaging device capable of photoelectrically converting visible light, and a displaying device capable of emitting visible light.

FIG. 21A illustrates glasses 2600 (smart glasses) according to one application example. An imaging device 2602 such as a complementary metal-oxide semiconductor (CMOS) sensor or a single photon avalanche diode (SPAD) is disposed on the front side of a lens 2601 of the glasses 2600. The display device according to any of the above-described exemplary embodiments is disposed on the back side of the lens 2601.

The glasses 2600 further include a control device 2603. The control device 2603 functions as a power source that supplies power to the imaging device 2602 and the display device according to the exemplary embodiments. The control device 2603 controls the operations of the imaging device 2602 and the display device. The lens 2601 is formed with an optical system for focusing light on the imaging device 2602.

FIG. 21B illustrates glasses 2610 (smart glasses) according to an application example. The glasses 2610 include a control device 2612. The control device 2612 includes an imaging device equivalent to the imaging device 2602 and a display device. The lens 2611 includes an optical system for projecting light emitted by the display device in the control device 2612, and an image is projected onto the lens 2611. The control device 2612 functions as a power source that supplies power to the imaging device and the display device, and controls the operations of the imaging device and the display device. The control device includes an image control unit that transmits an image control signal to a peripheral circuit of the light-emitting device. The control device may have a line of sight detection unit that detects the wearer's line of sight. Infrared light may be used for line of sight detection. The infrared light-emitting portion emits infrared light toward an eyeball of a user gazing at a display image. An imaging unit having a light receiving element obtains an image of the eyeball by detecting the reflected light of the emitted infrared light from the eyeball. A reduction unit that reduces the amount of light from the infrared light-emitting portion to the display unit in a plan view is disposed to reduce degradation in image quality.

The line of sight of the user on the display image is detected from an image of the eyeball obtained by capturing an image using infrared light. Any known methods can be applied to the line of sight detection using the image of the eyeball. As an example, a line of sight detection method based on the Purkinje image formed by reflection of light applied to the cornea can be used.

More specifically, line of sight detection processing is performed based on the pupil-corneal reflex method. Using the pupil-corneal reflex method, the user's line of sight is detected by calculating a line of sight vector that represents the direction (rotation angle) of the eyeball based on the pupil image and Purkinje image included in the captured image of the eyeball.

A display device according to one exemplary embodiment of the present disclosure includes an imaging device having a light receiving element, and may control a display image on the display device based on user's line of sight information from the imaging device.

Specifically, in the display device, a first display area at which the user gazes and a second display area other than the first display area are determined, based on the line of sight information. The first display area and the second display area may be determined by a control device of the display device, or an external control device may be determined and the display device receives the result. In the display area of the display device, the display resolution of the first display area may be controlled to be higher than the display resolution of the second display area. That is, the resolution of the second display area may be made lower than the resolution of the first display area.

The first display area and the second display area in the display area may be determined based on the line of sight information. Artificial intelligence (AI) may be used to determine the first display area or an area with high priority. The AI may be a model configured to inference, from the image of the eyeball, the line of sight angle and the distance to the object ahead of the line of sight, using, as training data, images of eyeballs and directions in which the eyeballs in the images actually look. The AI program may be included in the display device, the imaging device, or an external device. If included in an external device, the AI program is transmitted to the display device via communication.

When display control is performed based on visual recognition detection, the present disclosure can be suitably applied to smart glasses that further include an imaging device for capturing images of the outside. The smart glasses can display captured outside information in real time.

As described above, according to the present disclosure, it is possible to provide a light-emitting device in which leakage current of a light-emitting element is reduced.

According to the present disclosure, it is possible to provide a light-emitting element with reduced leakage current.

While the present disclosure has been described with reference to exemplary embodiments, it is to be understood that the disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2024-014807, filed Feb. 2, 2024, which is hereby incorporated by reference herein in its entirety.

What is claimed is:

1. A light-emitting device comprising:
a light-emitting element;
a first transistor and a second transistor disposed on a first surface of a silicon substrate; and
a third transistor disposed in a peripheral circuit configured to supply a video signal to the first transistor,
wherein one of a source or a drain of the first transistor is connected to a gate electrode of the second transistor,
wherein one of a source or a drain of the second transistor is connected to the light-emitting element, and
wherein the first transistor includes a halo injection layer in diffusion regions of the source and the drain, and the halo injection layer is opposite in polarity to the diffusion regions.

2. The light-emitting device according to claim 1, wherein the second transistor does not include a halo injection layer in diffusion regions of the source and the drain, and the halo injection layer is opposite in polarity to the diffusion regions.

3. The light-emitting device according to claim 2, wherein the third transistor includes a halo injection layer in diffusion regions of a source and a drain, and the halo injection layer is opposite in polarity to the diffusion regions.

4. The light-emitting device according to claim 3, wherein a peak impurity concentration in the halo injection layer of the first transistor is different from a peak impurity concentration in the halo injection layer of the third transistor.

5. The light-emitting device according to claim 4, wherein the peak impurity concentration in the halo injection layer of the first transistor is higher than the peak impurity concentration in the halo injection layer of the third transistor.

6. The light-emitting device according to claim 3, further comprising a fourth transistor disposed between the second transistor and a power source configured to supply electric current to the light-emitting element,
wherein the fourth transistor includes a halo injection layer in diffusion regions of a source and a drain,
wherein the halo injection layer is opposite in polarity to the diffusion regions,
wherein a peak impurity concentration in the halo injection layer of the third transistor is different from a peak impurity concentration in the halo injection layer of the fourth transistor.

7. The light-emitting device according to claim 6, wherein the peak impurity concentration in the halo injection layer of the fourth transistor is higher than the peak impurity concentration in the halo injection layer of the third transistor.

8. The light-emitting device according to claim 6, wherein the peak impurity concentration in the halo injection layer of the first transistor is the same as the peak impurity concentration in the halo injection layer of the fourth transistor.

9. The light-emitting device according to claim 3, further comprising a fifth transistor disposed between a terminal of the second transistor, the terminal being either the drain or source of the second transistor, which is connected to the light-emitting element, and a terminal lower in potential than a power source configured to supply electric current to the light-emitting element,
wherein the fifth transistor includes a halo injection layer in diffusion regions of a source and a drain, and the halo injection layer is opposite in polarity to the diffusion regions, and
wherein a peak impurity concentration in the halo injection layer of the third transistor is different from a peak impurity concentration in the halo injection layer of the fifth transistor.

10. The light-emitting device according to claim 9, wherein the peak impurity concentration in the halo injection layer of the fifth transistor is higher than the peak impurity concentration in the halo injection layer of the third transistor.

11. The light-emitting device according to claim 9, wherein a peak impurity concentration in the halo injection layer of the first transistor is the same as the peak impurity concentration in the halo injection layer of the fifth transistor.

12. The light-emitting device according to claim 1, wherein the peripheral circuit is disposed on the first surface of the silicon substrate.

13. The light-emitting device according to claim 1, wherein the peripheral circuit is disposed on a second silicon substrate different from the silicon substrate.

14. The light emitting device according to claim 1, further comprising an image control unit configured to transmit an image control signal to the peripheral circuit, wherein the light-emitting element is configured to emit light in response to the image control signal.

15. A photoelectric conversion device, comprising:
an optical unit having a plurality of lenses;
an imaging element configured to receive light that has passed through the optical unit; and
a display unit configured to display an image captured by the imaging element,
wherein the display unit includes the light emitting device according to claim 14.

16. Electronic equipment, comprising:
the light emitting device according to claim 14;
a housing in which the light emitting device is disposed; and
a communication unit disposed in the housing and configured to communicate with an outside.
